(19) United States
(12) Patent Application Publication
(10) Pub. No.: US 2019/0337387 A1
(43) Pub. Date: Nov. 7, 2019

(54) STEP MOTOR AND VEHICULAR INDICATOR INSTRUMENT

(71) Applicant: DENSO CORPORATION, Kariya-city (JP)

(72) Inventors: Tatsuya SASAKI, Kariya-city (JP); Ken TERAOKA, Kariya-city (JP)

(21) Appl. No.: 16/514,076

(22) Filed: Jul. 17, 2019

Related U.S. Application Data
(63) Continuation of application No. PCT/JP2018/008209, filed on Mar. 5, 2018.

(30) Foreign Application Priority Data
Apr. 13, 2017 (JP) 2017-079884

(51) Int. Cl. B60K 35/00; G01D 13/22; G01D 11/28; H02K 7/116; H02K 11/00; H02K 37/24; H02K 37/04

(52) U.S. Cl. CPC B60K 35/00; G01D 13/22; G01D 11/28; H02K 7/116; B60K 2370/691; H02K 37/24; H02K 37/04; B60K 2370/33; H02K 11/0094

(57) ABSTRACT

A motor casing accommodates a motor main body. A motor board has a mounting surface, on which the motor main body is mounted, a locking surface on the opposite side of the mounting surface, and a locking hole between the mounting surface and the locking surface. The motor casing has a locking arm and a locking claw. The locking arm is inserted in the locking hole in an elastically deformed state to extend obliquely with respect to the mounting surface and the locking surface. The locking claw has an abutment surface extending obliquely with respect to the mounting surface and the locking surface and locked to the motor board in a state where the abutment surface abuts against the locking corner portion. The locking corner portion is formed by the locking surface and a surface of the locking hole in the motor board.

### CROSS REFERENCE TO RELATED APPLICATIONS

The present application is a continuation application of International Patent Application No. PCT/JP2018/008209 filed on Mar. 5, 2018, which designated the United States and claims the benefit of priority from Japanese Patent Application No. 2017-079884 filed on Apr. 13, 2017. The entire disclosures of all of the above applications are incorporated herein by reference.

### TECHNICAL FIELD

The present disclosure relates to a step motor. The present disclosure further relates to a vehicular indicator instrument including the step motor.

### BACKGROUND

Conventionally, a vehicular meter has been widely used to provide indication relevant to a vehicle to an occupant.

### SUMMARY

According to one aspect of the present disclosure, a step motor includes a motor main body, a motor casing, and a motor board. The motor main body is configured to apply a rotational driving force to a rotational body. The motor casing accommodates the motor main body. The motor board holds the motor casing.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a front view showing an indicator instrument for a vehicle according to a first embodiment.

FIG. 2 is a cross-sectional view showing an indicator instrument for a vehicle including a step motor according to the first embodiment, and is a cross-sectional view taken along a line II-II of FIG. 1.

FIG. 3 is an exploded perspective view showing a step motor according to the first embodiment.

FIG. 4 is a plan view showing an inside of the step motor according to the first embodiment.

FIG. 5 is a perspective view showing the inside of the step motor according to the first embodiment.

FIG. 6 is a plan view showing a step motor according to the first embodiment.

FIG. 7 is a cross-sectional view taken along a line VII-VII of FIG. 6.

FIG. 8 is a side view taken along a line VIII-VIII of FIG. 6.

FIG. 9 is a side view taken along a line IX-IX of FIG. 6.

FIG. 10 is a bottom view showing a step motor according to the first embodiment.

FIG. 11 is a cross-sectional view taken along a line XI-XI of FIG. 10.

FIG. 12 is an enlarged cross-sectional view showing a part of FIG. 11.

FIG. 13 is a schematic diagram illustrating functions of a locking arm and a locking claw according to the first embodiment.

FIG. 14 is an enlarged cross-sectional view showing a part of a step motor according to a second embodiment, which is a cross-sectional view corresponding to FIG. 12.

FIG. 15 is a cross-sectional view showing a modification of FIG. 11.

### DESCRIPTION OF EMBODIMENTS

Hereinafter, multiple embodiments of the present disclosure will be described with reference to the drawings. The same reference numerals are assigned to the corresponding components in each embodiment, and thus, duplicate descriptions may be omitted. When only a part of the configuration is described in each embodiment, the configuration of the other embodiments described above can be applied to other parts of the configuration. Further, not only the combinations of the configurations explicitly shown in the description of the respective embodiments, but also the configurations of the multiple embodiments can be partially combined even if the combinations are not explicitly shown if there is no problem in the combination in particular.

To begin with, an example of the present disclosure will be described. According to an example, a step motor includes a motor main body that applies a rotational driving force to a rotational body, a motor casing that accommodates the motor main body, and a motor board that holds the motor casing. In this example, the motor board has a mounting surface on which the motor main body is mounted via the motor casing, an opposite locking surface, and a locking hole that penetrates between those two surfaces. The motor casing has a locking arm inserted in the locking hole of the motor board in an elastically deformed state, and a locking claw locked by the motor board. The configuration described above has a mounting configuration, in which the motor main body is mounted on the motor board via the motor casing. Thus, the configuration may increase its vibration resistant strength and could enable to enhance durability.

In the example, a conceivable configuration of the locking arm will be described as follows. Specifically, in the conceivable configuration, the locking arm may abut against an inner surface of the locking hole along a direction perpendicular to both surfaces of the motor board. In addition, the locking claw may abut against the locking surface along a direction parallel to both the surfaces of the motor board. In the conceivable configuration, the locking arm is still elastically deformed, so that a load in the parallel direction may act at the abutment portion of the locking arm against the inner surface of the locking hole. In addition, a load in the vertical direction may act at the abutment portion of the locking claw against the locking surface. However, in order to apply a sufficient load in such an abutment state, the conceivable configuration could require, particularly in the parallel direction, a length of the locking arm. As a result, a concern may arise that miniaturization is hindered.

### First Embodiment

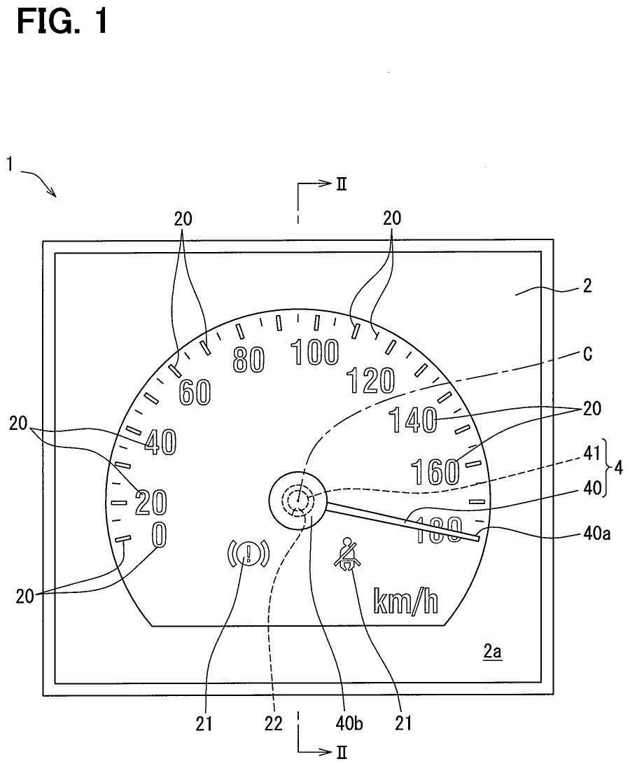

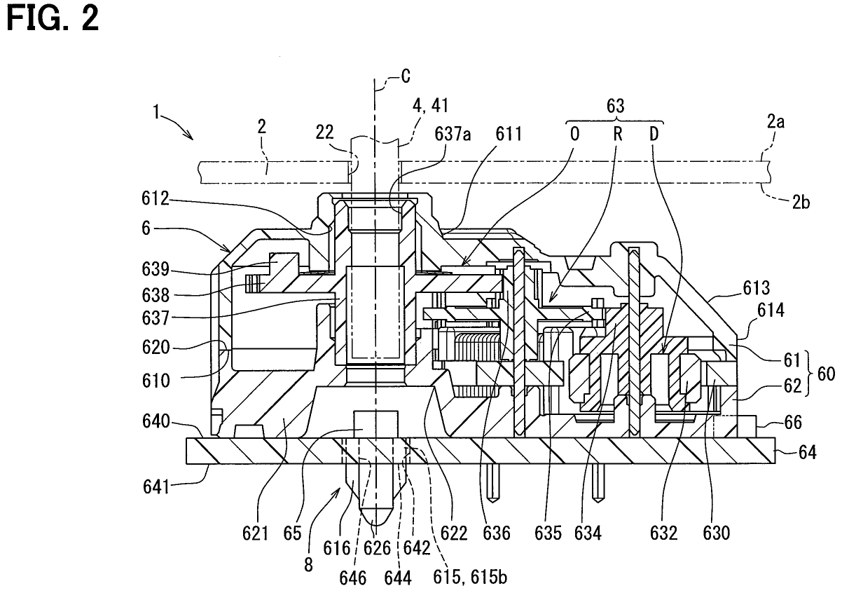

As shown in FIGS. 1 and 2, an indicator instrument 1 for a vehicle according to a first embodiment of the present disclosure is installed on an instrument panel in the vehicle. The indicator instrument 1 for a vehicle includes a display member 2, a rotational indicator 4, and a step motor 6. In the following description, a “viewing side” means a side on which a display of the instrument 1 is visually recognized by an occupant on a driver's seat in the vehicle, and an “anti-viewing side” means a side opposite to the “viewing side”.

The display member 2 is formed by laminating a light shielding printing layer on a light transmissive base material such as a polycarbonate resin or the like, and has a flat plate-like shape as a whole. A display surface 2a, which is one surface of the display member 2, is located toward the viewing side. As shown in FIG. 1, in an open portion of the light shielding printing layer in the display member 2, numbers and scales arranged in a rotation direction of the rotational indicator 4 are formed as an index 20 in order to display a “vehicle state value”. In this example, the “vehicle state value” in the present embodiment is a vehicle speed value as shown in FIG. 1, but may be a physical quantity such as an engine speed involved in the vehicle, for example. Further, a warning lamp 21 for issuing a warning is formed around a rotation shaft 41 of the rotational indicator 4 in an open portion of the light shielding printing layer in the display member 2.

The rotational indicator 4 as a “rotational body” is made of a light transmissive resin material such as an acrylic resin, and has an indicator main body 40 and a rotation shaft 41. The indicator main body 40 has an elongated needle shape as a whole, and is located on the viewing side of the display surface 2a of the display member 2. The indicator main body 40 instructs the “vehicle state value” represented by the index 20 according to a rotational position by a point 40a. As shown in FIGS. 1 and 2, the rotation shaft 41 has a columnar shape extending from a base end 40b of the indicator main body 40 to the anti-viewing side as a whole. The rotation shaft 41 is inserted into an indicator hole 22 that penetrates between two surfaces 2a and 2b in the display member 2. The rotation shaft 41 is connected to the step motor 6 on an anti-viewing side of the back surface 2b of the display member 2. As a result, the step motor 6 realizes the indication described above by the indicator main body 40 by rotationally driving the rotational indicator 4 around the rotation center line C which is the axis line of the rotation shaft 41.

As shown in FIG. 2, the step motor 6 is located on the anti-viewing side of the back surface 2b of the display member 2. The step motor 6 includes a motor casing 60, a motor main body 63, a motor board 64, and light sources 65 and 66.

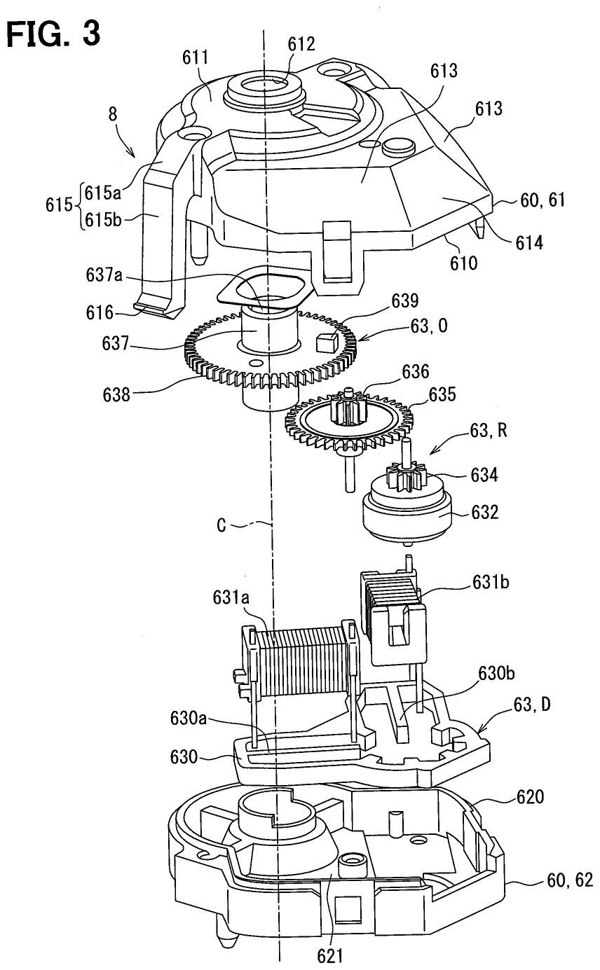

As shown in FIGS. 2 and 3, the motor casing 60 is formed by combining a pair of case members 61 and 62, and has a hollow shape as a whole. The case members 61 and 62 are each made of a light shielding resin material such as modified polyphenylene ether resin (m-PPE), and are each formed in a cup-like shape. The case members 61 and 62 are coupled to each other by snap-fit fitting in a state in which respective opening edge portions 610 and 620 overlap with each other. Each of the case members 61 and 62 has through holes 612 and 622 that penetrate through bottom portions 611 and 621 on the rotation center line C of the indicator main body 40, respectively. The first case member 61 is located to face the back surface 2b on the anti-viewing side of the display member 2. The second case member 62 is located on the anti-viewing side of the first case member 61.

As shown in FIG. 2, the motor board 64 is formed by laminating a metal wiring layer on a printed circuit board such as a glass epoxy substrate or the like, and has a flat plate-like shape as a whole. The motor board 64 is located on the anti-viewing side of the motor casing 60. A mounting surface 640, which is one surface of the motor board 64 on the viewing side, has a planar shape. The motor casing 60 and the light sources 65 and 66 are held on the mounting surface 640.

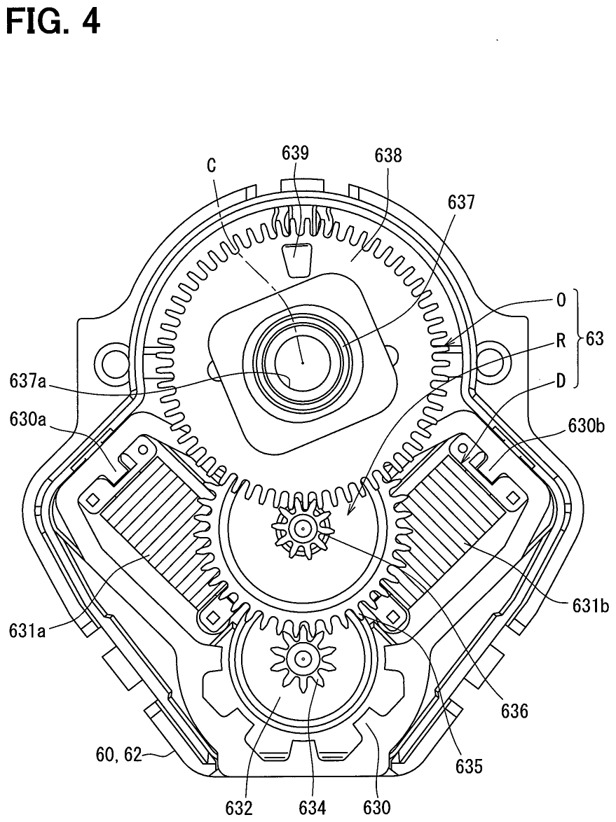

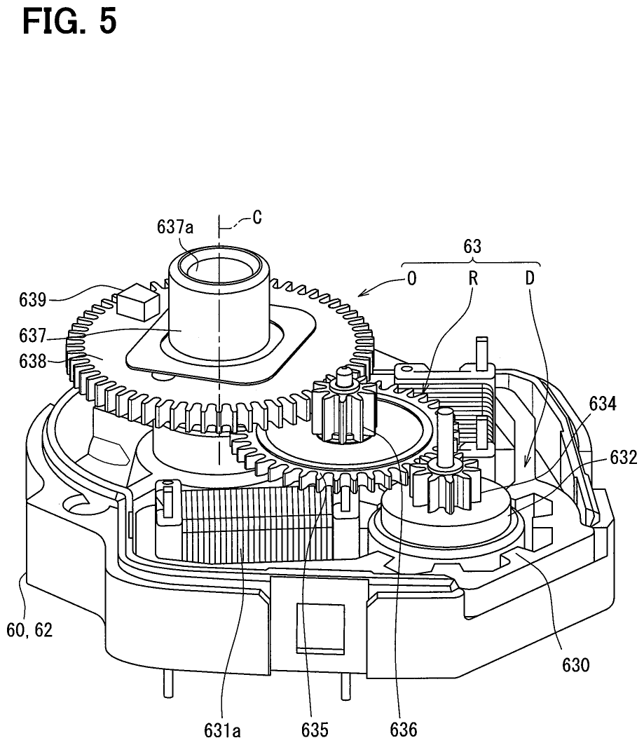

As shown in FIGS. 2 to 5 and 11, the motor main body 63 is accommodated in the motor casing 60. As a result, the motor main body 63 is mounted on the mounting surface 640 of the motor board 64 through the motor casing 60. The motor main body 63 includes a driving source D, a speed reduction mechanism R, and a rotation output mechanism O.

As shown in FIGS. 2 to 5, the driving source D is formed by combining a yoke 630, two-phase coils 631a and 631b, and a magnet rotor 632 together, and is deviated from the rotation center line C of the indicator main body 40 in a radial direction. The yoke 630 is formed in a frame shape and made of a magnetic metal material such as iron and is fixed to the motor casing 60. The yoke 630 has a pair of magnetic poles 630a and 630b protruding toward an inner peripheral side. The coil 631a of the A-phase is wound around one magnetic pole 630a, and the coil 631b of the B-phase is wound around the other magnetic pole 630b. The coils 631a and 631b of the A- and B-phases are electrically connected to a metal wiring layer of the motor board 64 through a through hole that penetrates through the second case member 62 of the motor casing 60.

The magnet rotor 632 is formed in a disc shape and made of a magnetic metal material such as ferrite and is spaced from each of the magnetic poles 630a and 630b and located on the inner peripheral side of the yoke 630. The magnet rotor 632 is radially supported and thrust-supported by the motor casing 60 so as to be rotatable about an axis line substantially parallel to the rotation center line C of the indicator main body 40. N and S poles as magnetic poles are alternately magnetized in the rotation direction at an outer peripheral portion of the magnet rotor 632.

In the driving source D configured as described above, AC signals having phases shifted by 90 degrees from each other are applied to the coils 631a and 631b of the phases A and B from an external control circuit through a metal wiring layer of the motor board 64. As a result, the alternating magnetic flux generated in each of the coils 631a and 631b passes between the yoke 630 and the magnet rotor 632, thereby driving the rotor 632 to a predetermined rotational position.

The speed reduction mechanism R is formed by combining a magnet gear 634, an idle gear 635, and a pinion gear 636 together, and is located radially away from the rotation center line C of the indicator main body 40. The magnet gear 634 is made of a hard resin material such as polyacetal resin (POM), and has a spur gear shape. The magnet gear 634 is radially supported and thrust-supported by the motor casing 60 so as to be integrally rotatable with the magnet rotor 632.

The idle gear 635 and the pinion gear 636 are formed integrally coaxially with each other and made of a hard resin material such as polybutylene terephthalate resin (PBT), and each have a spur gear shape.

The idle gear 635 and the pinion gear 636 are radially supported and thrust-supported by the motor casing 60 so as to be integrally rotatable about an axis line substantially parallel to the rotation center line C of the indicator main body 40. The idle gear 635 meshes with the magnet gear 634 to decelerate the rotation of the gear 634.

As shown in FIGS. 2 to 5 and 11, the rotation output mechanism O is formed by combining an output shaft 637, an output gear 638, and a rotation stopper 639, and is located on the rotation center line C of the indicator main body 40. The output shaft 637, the output gear 638, and the rotation stopper 639 are integrally made of a hard resin material such as polyacetal resin (POM). The output shaft 637, the output gear 638, and the rotation stopper 639 are radially supported and thrust-supported by the motor casing 60 so as to be integrally rotatable about the rotation center line C of the indicator main body 40.

The output shaft 637 has a cylindrical shape as a whole. The rotation shaft 41 of the rotational indicator 4 is coaxially press-fitted into a center hole 637a of the output shaft 637. As a result, the output shaft 637 rotates around the rotation center line C together with the rotational indicator 4, thereby outputting a rotational driving force to the indicator 4. The output gear 638 has a spur gear shape extending from the output shaft 637 to the outer peripheral side. As shown in FIGS. 2, 4, and 5, the output gear 638 meshes with the pinion gear 636 of the speed reduction mechanism R to reduce the rotation of the gear 636. With the above configuration, in the motor main body 63, the rotational driving force increased by a deceleration action of the speed reduction mechanism R from the driving source D is given from the rotation output mechanism O to the rotational indicator 4.

As shown in FIGS. 2 to 5, the rotation stopper 639 has a protruding piece shape protruding from the output gear 638 toward the viewing side. The rotation stopper 639 is provided so as to be lockable by fixed stoppers of the motor casing 60 at limit positions on both sides of the rotational indicator 4 which determine a rotation range of the rotational indicator 4. As a result, even if the rotational driving force is applied from the rotation output mechanism O to the rotational indicator 4, the rotation of the rotational indicator 4 out of the rotation range is limited.

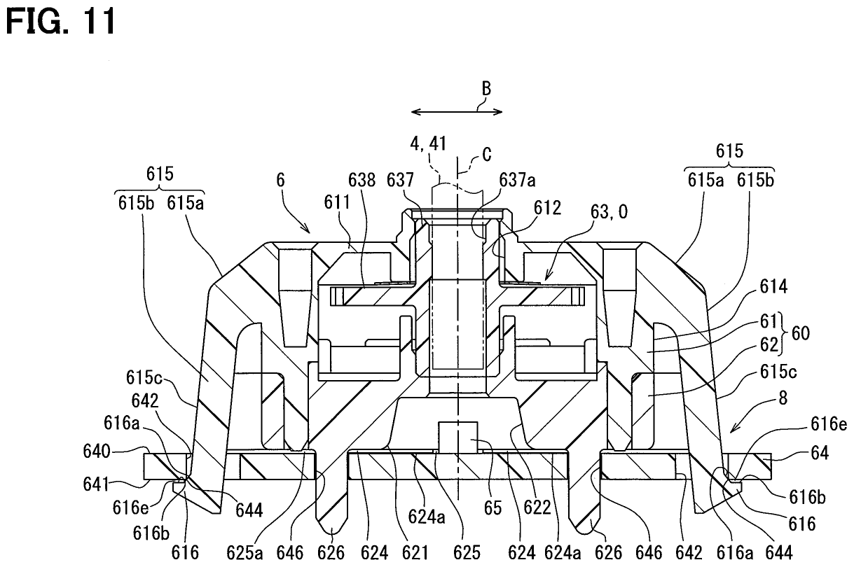

As shown in FIGS. 2 and 11, the rotational body illumination light source 65 is located on the rotation center line C of the indicator main body 40 in the through hole 622 of the second case member 62, and is mounted on the mounting surface 640 of the motor board 64. The rotational body illumination light source 65 mainly includes LEDs (Light Emitting Diode) and is electrically connected to a metallic wiring layer of the motor board 64. The rotational body illumination light source 65 emits a light by being energized by an external control circuit through the metal wiring layer. The light emitted from the rotational body illumination light source 65 passes through the through hole 622 of the second case member 62 and the center hole 637a of the output shaft 637, and is incident on the rotation shaft 41 of the rotational indicator 4, thereby being guided to the indicator main body 40 of the rotational indicator 4. As a result, the rotational indicator 4 is illuminated across the motor main body 63, so that the indicator main body 40 is visually recognized in a light-emitting state.

As shown in FIGS. 2, 6, and 7, the multiple display illumination light sources 66 are located around the second case member 62 and mounted on the mounting surface 640 of the motor board 64. Each of the display illumination light sources 66 mainly includes an LED, and is electrically connected to the metal wiring layer of the motor board 64. Each of the display illumination light sources 66 emits light by being energized by an external control circuit through the metal wiring layer at the time of necessary warning. The light emitted from the display illumination light source 66 passes around the motor casing 60 and is incident on the display member 2. As a result, the display member 2 is directly illuminated, so that the warning lamp 21 is visually recognized in a light emitting state at the time of necessary warning.

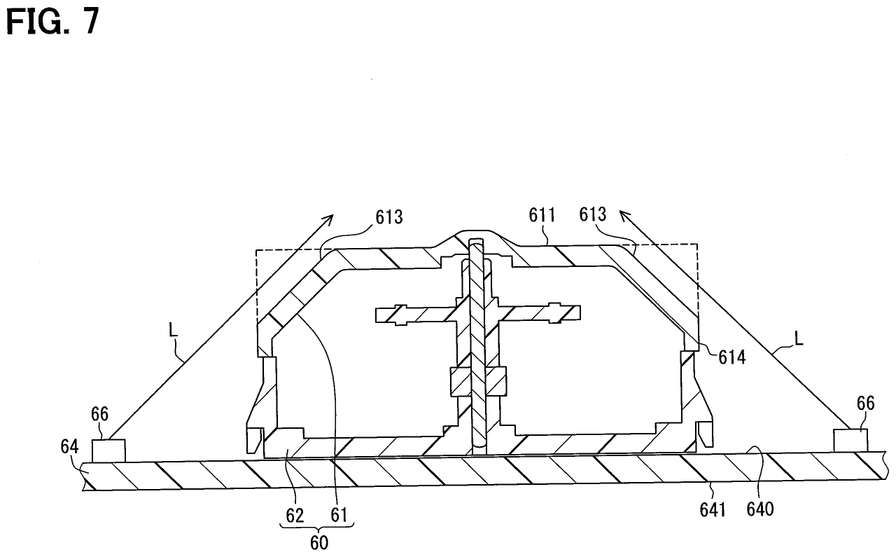

The display illumination light source 66 is located as close as possible to the motor casing 60 on the mounting surface 640 of the motor board 64. Therefore, in order to properly open the optical path L (refer to FIG. 7) from the display illumination light source 66 side to the display member 2 side in the motor casing 60, the first case member 61 of the casing 60 is provided with multiple chamfered portions 613 as shown in FIGS. 2, 3, 6 to 9. Each of the chamfered portions 613 is chamfered from the bottom portion 611 across the side wall portion 614 in the first case member 61. Each of the chamfered portions 613 has a plane shape (that is, a slope shape) inclined with respect to the rotation center line C and the mounting surface 640. In this example, each chamfered portion 613 of the present embodiment is inclined toward the rotation center line C side toward the viewing side.

### Mounting Structure

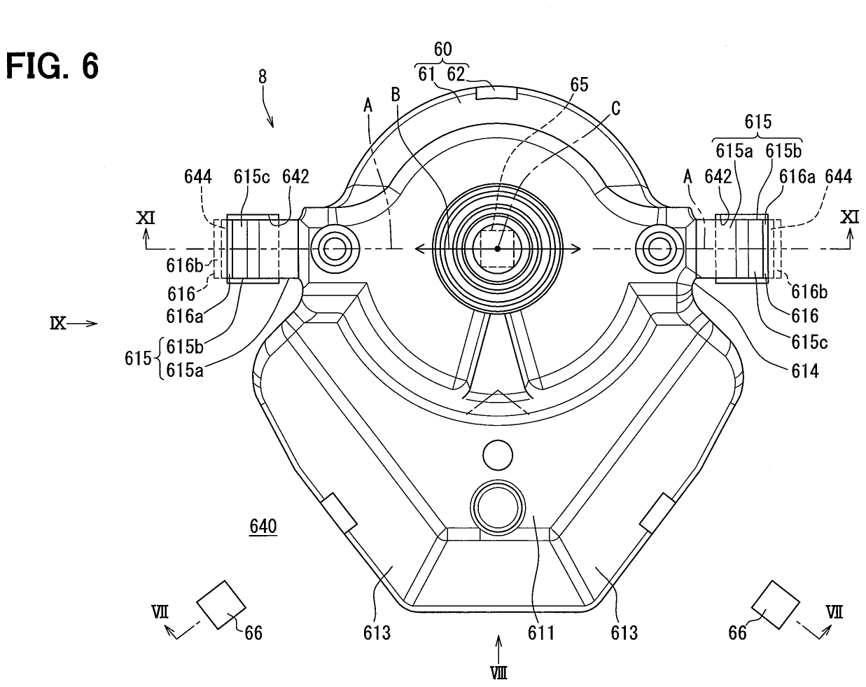

Next, the mounting structure 8 of the first embodiment shown in FIGS. 2, 4, 6, 8 to 13 will be described in detail. As shown in FIGS. 6, 10, and 11, in the mounting structure 8, one radial direction substantially orthogonal to the rotation center line C and not substantially passing through the driving source D and the speed reduction mechanism R is defined as a reference direction B.

As shown in FIGS. 2, 6, 8 to 12, the motor board 64 has a mounting surface 640, a locking surface 641 and locking holes 642. The locking surface 641 has a planar shape substantially parallel to the mounting surface 640 as a surface on the viewing side opposite to the mounting surface 640 in the motor board 64. The locking holes 642 are provided one by one on both sides of the rotational body illumination light source 65 on the rotation center line C in the reference direction B. Each of the locking holes 642 penetrates between the mounting surface 640 and the locking surface 641 in the motor board 64 substantially perpendicularly to both surfaces 640 and 641. In this example, each locking hole 642 of the present embodiment has a straight rectangular hole shape along the rotation center line C. As a result, each locking hole 642 is defined with a ridge-like locking corner portion 644 between the locking hole 642 and the locking surface 641 so as to be substantially perpendicular to a longitudinal cross section.

As shown in FIGS. 2, 3, 6, 8 to 12, the first case member 61 of the motor casing 60 integrally has sets of locking arms 615 and locking claws 616. The respective sets of the locking arm 615 and the locking claws 616 are provided on both sides of the rotational body illumination light source 65 on the rotation center line C in the reference direction B. In other words, the pairs of the locking arms 615 and the locking claws 616 are respectively provided on both sides of the rotational body illumination light source 65 on a virtual plane A along the reference direction B (refer to FIGS. 6, 9, and 10).

As shown in FIGS. 6, 8 to 11, each locking arm 615 is formed in the shape of an elastic spring having a rectangular cross section that bends in one step. A base portion 615a of each locking arm 615 projects obliquely from the side wall portion 614 to the anti-viewing side in the first case member 61. An elastic arm portion 615b of each locking arm 615 is bent from the base portion 615a in the first case member 61 and extends obliquely to the anti-viewing side. In each of the locking arms 615, the elastic arm portion 615b is inserted into the corresponding locking hole 642 from the viewing side and penetrates to the anti-viewing side. As a result, each locking arm 615 is in a state in which the elastic arm portion 615b extends obliquely with respect to the rotation center line C and both surfaces 640 and 641 of the motor board 64 and is inserted into the corresponding locking hole 642, and each locking arm 615 is elastically deformed with the base portion 615a as a fulcrum. In this example, each of the locking arms 615 of the present embodiment is inclined toward the outside of the reference direction B toward the anti-viewing side in the state of being inserted into the corresponding locking hole 642.

Each of the locking claws 616 has a hook shape protruding from the same set of locking arms 615 to the outer peripheral side in the first case member 61. As shown in FIGS. 6, 8, 9, 11 and 12, each locking claw 616 has an abutment surface 616a and a facing surface 616b.

In each of the locking claws 616, the abutment surface 616a is bent from a slope 615c facing outward in the reference direction B in the same set of elastic arm portions 615b, and extends toward the anti-viewing side and the outer facing surface 616b. The abutment surface 616a of each locking claw 616 extends in a plane shape (a slope shape) which is inclined with respect to the rotation center line C and both surfaces 640 and 641 of the motor board 64. In this example, in each of the locking claws 616 according to the present embodiment, the abutment surface 616a is inclined toward the outside in the reference direction B toward the anti-viewing side in the state in which the same set of locking arms 615 are inserted into the respective locking holes 642. As shown in FIG. 13, an inclination angle θa formed by the abutment surface 616a on both surfaces 640 and 641 of the motor board 64 in each of the locking claws 616 is set so as to be smaller than an inclination angle θb formed by the slope 615c and the two surfaces 640 and 641 in the same set of locking arms 615, particularly, is set to be 45 degrees in the present embodiment.

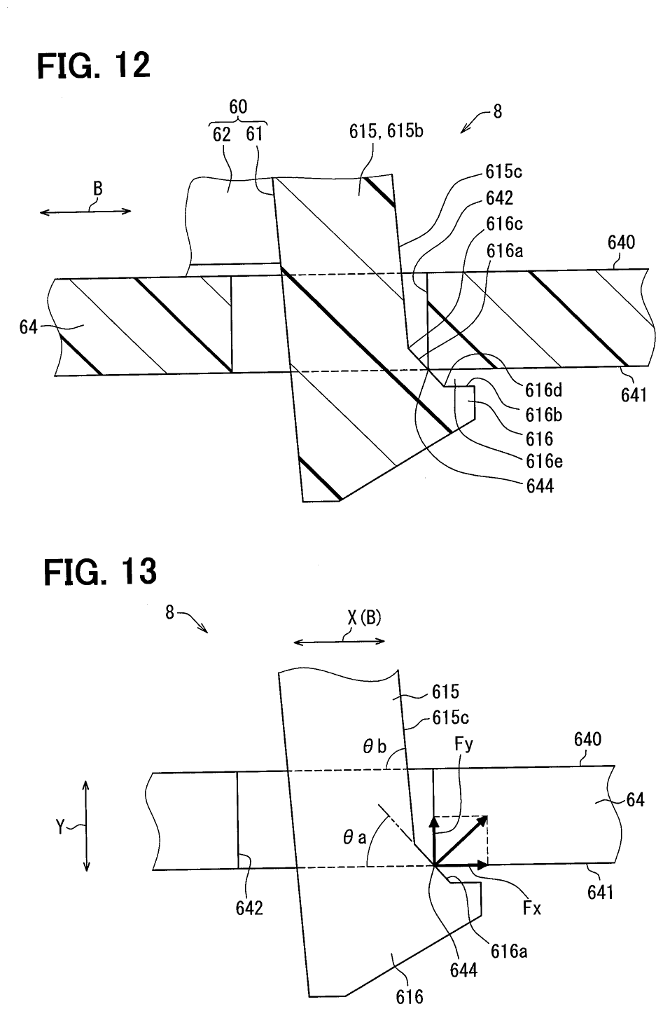

In each of those locking claws 616, as shown in FIGS. 6, 8, 9, 11, and 12, the abutment surface 616a abuts against the locking corner portion 644 formed by the surface of the corresponding locking hole 642 with the locking surface 641 in the motor board 64 in a state of substantial line contact. As a result, each of the locking claws 616 applies a restoring force generated by the same set of locking arms 615 that have been elastically deformed to the locking corner portion 644 that abuts as shown in FIG. 13. As a result, necessary loads Fx and Fy act on the abutment portion where the abutment surface 616a abuts against the corresponding locking corner portion 644, in a parallel direction X parallel to the both surfaces 640 and 641 of the motor board 64 (substantially coincident with the reference direction B in the present embodiment) and a vertical direction Y to the both surfaces 640 and 641, so that the locking claws 616 are locked and held by the motor board 64. In this example, as shown in FIG. 12, in each of the locking claws 616 of the present embodiment, the abutment surface 616a is formed in a size so as to abut against the corresponding locking corner portion 644 at an intermediate portion between the boundary portions 616c and 616d with the same set of the locking arm 615 and the facing surface 616b.

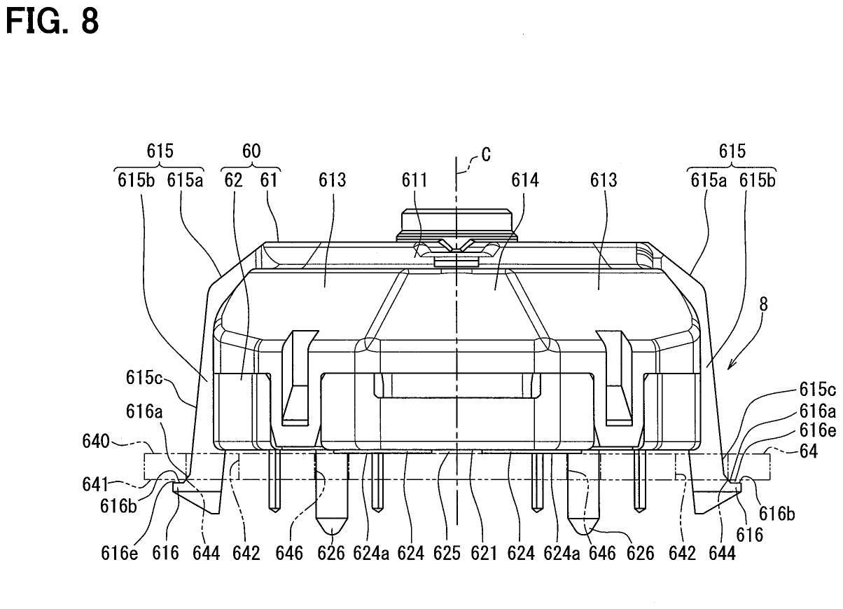

In each of the locking claws 616 shown in FIGS. 8, 9, 11, and 12, the facing surface 616b is bent from the abutment surface 616a and extends outward in the reference direction B. As a result, the facing surface 616b of each locking claw 616 extends in a planar shape facing the locking surface 641 of the motor board 64 on the opposite side of the elastic arm portion 615b of the same set of locking arms 615 across the abutment surface 616a. In this example, in each of the locking claws 616 of the present embodiment, the facing surface 616b is opposed to the locking surface 641 substantially in parallel with the predetermined gap 616e in a state in which the same set of locking arms 615 are inserted into the respective locking holes 642.

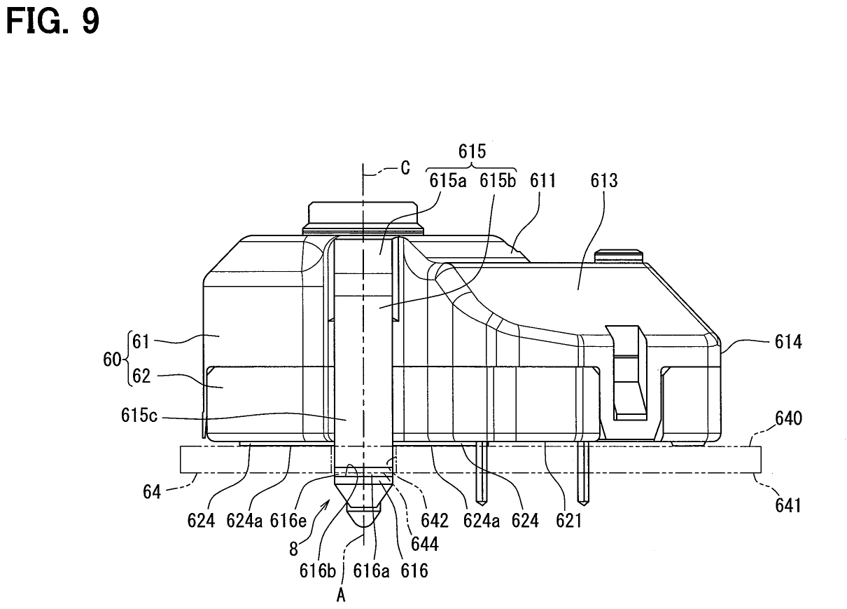

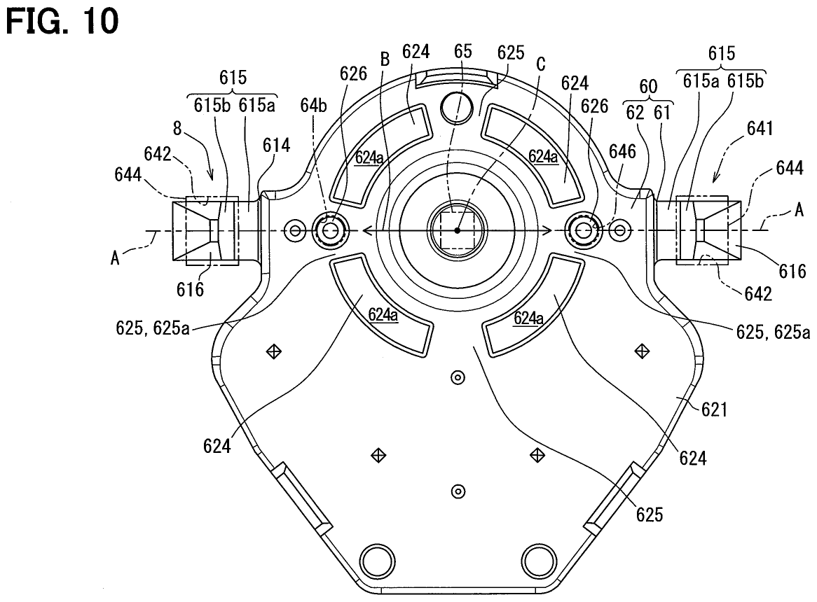

As shown in FIGS. 8 to 11, the second case member 62 of the motor casing 60 has dike protrusions 624 dispersed at a plurality of positions around the rotational body illumination light source 65 on the rotation center line C. Each dike protrusion 624 is substantially equally spaced around the rotational body illumination light source 65, avoiding on and in the vicinity of a virtual plane A (refer to FIGS. 9 and 10) along a reference direction B. Each of the dike protrusions 624 slightly protrudes from the bottom portion 621 of the second case member 62 toward the anti-viewing side, and a protruding tip end face 624a is formed in a planar shape capable of coming in surface contact with the mounting surface 640 of the motor board 64. In this example, each dike protrusion 624 of the present embodiment has an arc wall shape extending around the rotation center line C. Each of the dike protrusions 624 configured as described above abuts against the mounting surface 640 in a surface contact state. As a result, as shown in FIGS. 8, 10, and 11, the dike protrusions 624 adjacent to each other in the circumferential direction around the rotation center line C have gaps 625 as spaces interposed between the bottom portion 621 and the motor board 64.

As shown in FIGS. 2, 8, 10, and 11, the second case member 62 of the motor casing 60 has one positioning protrusion 626 on each of both sides of the rotational body illumination light source 65 on the rotation center line C in the reference direction B. Each of the positioning protrusions 626 protrudes from the bottom portion 621 of the second case member 62 to the anti-viewing side with a thickness greater than or equal to the thickness of the motor board 64. In this example, each positioning protrusion 626 of the present embodiment has a straight cylindrical pin shape along the rotation center line C.

The motor board 64 has one positioning hole 646 at a position corresponding to the positioning protrusion 626 on each of both sides of the rotational body illumination light source 65 on the rotation center line C in the reference direction B. Each positioning hole 646 penetrates between the mounting surface 640 and the locking surface 641 in the motor board 64 substantially perpendicularly to both the surfaces 640 and 641. In this example, each positioning hole 646 of the present embodiment has a straight cylindrical hole shape along the rotation center line C.

The corresponding positioning protrusion 626 is coaxially fitted and inserted in each positioning hole 646, so that the second case member 62 is positioned and held on the motor board 64. As described above, the respective pairs of the positioning protrusions 626 and the positioning holes 646 that exert the positioning function are provided on both sides of the rotational body illumination light source 65 on the rotation center line C in the reference direction B. In this example, as shown in FIGS. 8, 10, and 11, in the present embodiment, the set of the positioning protrusion 626 and the positioning hole 646 is placed closer to the rotational body illumination light source 65 inside the set of the locking arm 615 and the locking claw 616 on the corresponding side in the reference direction B. Along with the above placement, the positioning protrusions 626 of the present embodiment are aligned with gaps 625a positioned on the virtual plane A (refer to FIG. 10) along the reference direction B among the gaps 625 between the dike protrusions 624.

### Operation and Effects

The operation and effects of the first embodiment described above will be described below.

According to the first embodiment, the locking claw 616 locked to the motor board 64 in the motor casing 60 causes the mounting surface 640 of the motor board 64 and the abutment surface 616a extending obliquely to the locking surface 641 to abut against the locking corner portion 644 formed by the locking surface 641 and the locking hole 642 in the motor board 64. According to the above configuration, the locking arm 615 is inserted into the locking hole 642 so as to be in an elastically deformed state extending obliquely with respect to the mounting surface 640 and the locking surface 641 of the motor board 64. As a result, the necessary loads Fx and Fy can act on the abutment portion of the abutment surface 616a against the locking corner portion 644 in the parallel direction X and the vertical direction Y to the both surfaces 640 and 641. Therefore, in order to increase the vibration resistant strength by the mounting structure 8 of the motor main body 63 to the motor board 64 via the motor casing 60, a need to secure the length of the locking arm 615 along the parallel direction X can be eliminated. As described above, the mounting structure 8 with improved durability can be reduced in size.

In addition, according to the first embodiment, a length of the diagonally extending locking arm 615 can be set so as to reduce each of the necessary loads Fx and Fy in the parallel direction X and the vertical direction Y to the degree necessary for securing the vibration resistant strength. According to the setting described above, since a load variation caused by a manufacturing tolerance of the abutment surface 616a and the locking corner portion 644 in the abutting state can be reduced, a design for securing the vibration resistant strength for improving the durability becomes facilitated.

In accordance with the first embodiment, the facing surface 616b are formed on the opposite side of the locking arm 615 across the abutment surface 616a in the locking claw 616 to face the locking surface 641 of the motor board 64. According to the above configuration, even if the locking arm 615 attempts to escape from the locking hole 642, the facing surface 616b is locked to the locking surface 641 to restrict the escape, thereby being capable of maintaining the abutment state of the abutment surface 616a against the locking corner portion 644. Therefore, the vibration resistant strength can be secured by the downsized mounting structure 8, and the durability can be improved.

In addition, according to the first embodiment, the abutment surface 616a abuts against the locking corner portion 644 between the boundary portions 616c and 616d between each of the locking arm 615 and the facing surface 616b and the abutment surface 616a, as a result of which the necessary loads Fx and Fy can be reliably applied in both the parallel direction X and the vertical direction Y. This makes it possible to secure the vibration resistant strength in both directions X and Y by the downsized mounting structure 8 and to improve the durability.

Further, according to the first embodiment, the abutment surface 616a extending at an inclination angle θa of 45 degrees with respect to the both surfaces 640 and 641 of the motor board 64 abuts against the locking corner portion 644 between the boundary portions 616c and 616d. As a result, the necessary loads Fx and Fy having substantially the same magnitude can be applied in the parallel direction X and the vertical direction Y. According to the above configuration, the vibration resistant strength against both the vibration in the parallel direction X and the vibration in the vertical direction Y can be ensured by the downsized mounting structure 8, and the reliability of the durability improvement effect can be enhanced.

According to the first embodiment, the rotational body illumination light source 65 is mounted on the mounting surface 640 of the motor board 64 together with the motor casing 60. Therefore, the illumination of the rotational indicator 4 by the emitted rotational body illumination light source 65 is enabled across the motor main body 63 mounted on the motor board 64 via the motor casing 60 by the mounting structure 8 whose vibration resistant strength has been secured. This also makes it possible to stabilize the illumination state of the rotational indicator 4 by effectively utilizing the small mounting structure 8 which improves the durability.

In addition, according to the first embodiment, since the function by the combination of the locking arm 615 and the locking claw 616 can be exerted on both sides of the rotational body illumination light source 65 in the reference direction B, the durability improvement effect and the downsizing effect can be promoted.

Further, according to the first embodiment, the motor casing 60 is positioned on the motor board 64 by fitting the positioning protrusions 626 of the motor casing 60 and the positioning holes 646 of the motor board 64 on both sides of the rotational body illumination light source 65 in the reference direction B. According to the above configuration, the alignment of the rotational body illumination light source 65 relative to the motor main body 63 can be achieved by the sets of the positioning protrusions 626 and the positioning holes 646 on the both sides, separately from the achievement of the vibration resistant strength by the set of the locking arms 615 and the locking claws 616 on the both sides. This makes it possible to stabilize the illumination state independently of the promotion of the durability improvement effect and the downsizing effect.

Further, according to the first embodiment, the positioning accuracy of the motor casing 60 relative to the motor board 64 can be enhanced by arranging the sets of the positioning protrusions 626 and the positioning holes 646 closer to the rotational body illumination light source 65 than the sets of the locking arms 615 and the locking claws 616 on both sides of the rotational body illumination light source 65 in the reference direction B. According to the above configuration, since the rotational body illumination light source 65 can be accurately aligned relative to the motor main body 63, the effect of stabilizing the illumination state can be promoted.

In addition, according to the first embodiment, the dike protrusions 624 dispersed and protruded at multiple positions around the rotational body illumination light source 65 in the motor casing 60 are in surface contact with the mounting surface 640 of the motor board 64, thereby forming the gaps 625 between the dike protrusions 624. According to the above configuration, while the vibration resistant strength against vibration in the vertical direction Y is increased by pressing the multiple dike protrusions 624 against the mounting surface 640 in the surface contact state, the heat of the rotational body illumination light source 65 can be released through the gaps 625 between the dam projections 624. Therefore, not only the durability due to vibration but also the durability due to heat can be improved.

In addition, according to the first embodiment, since the positioning protrusions 626 are located by effectively utilizing the gaps 625 between the dike protrusions 624 on both sides of the rotational body illumination light source 65 in the reference direction B, downsizing can be promoted.

In addition, according to the first embodiment, the display member 2 displaying the vehicle state value indicated by the rotational indicator 4 is illuminated by the light emission of the display illumination light source 66 mounted on the mounting surface 640 of the motor board 64. In this example, in the motor casing 60 mounted on the same mounting surface 640 as the display illumination light source 66, the chamfered portion 613 is chamfered so as to open the optical path L from the light source 66 side to the display member 2 side. According to the above configuration, while the display illumination light source 66 is located in the vicinity of the motor casing 60 to promote downsizing, the light from the light source 66 can be prevented from being blocked by the motor casing 60, and the illumination efficiency of the display member 2 can be enhanced.

### Second Embodiment

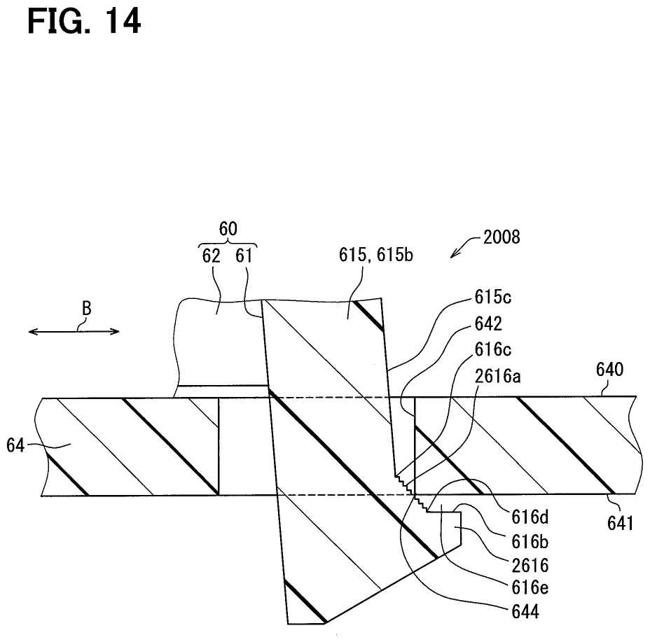

As shown in FIG. 14, a second embodiment of the present disclosure is a modification of the first embodiment.

In a mounting structure 2008 of the second embodiment, an abutment surface 2616a of each of locking claws 2616 is formed in the shape of a embossed surface to which a minute roughness (for example, 100 μm in size) is imparted. The abutment surface 2616a formed in the embossed surface shape abuts against a corresponding locking corner portion 644 between boundary portions 616c and 616d, thereby making it difficult to deviate an abutment portion where the necessary loads Fx and Fy are applied in both of a parallel direction X and a vertical direction Y. According to the above configuration, a vibration resistant strength against both the vibration in the parallel direction X and the vibration in the vertical direction Y can be ensured by a downsized mounting structure 2008, and the reliability of the durability improvement effect can be enhanced.

### Other Embodiments

Although a plurality of embodiments of the present disclosure have been described above, the present disclosure is not construed as being limited to these embodiments, and can be applied to various embodiments and combinations within a scope without departing from the spirit of the present disclosure.

Specifically, in Modification 1, the facing surface 616b may not be provided on each of the locking claws 616 and 2616. In Modification 2, the abutment surfaces 616a and 2616a may abut against the locking corner portion 644 at one of the boundary portions 616c and 616d between each of the locking arm 615 and the facing surface 616b and the abutment surfaces 616a and 2616a. In Modification 3, the abutment surfaces 616a and 2616a may be formed so as to extend at an inclination angle θa of less than 45 degrees or more than 45 degrees with respect to the both surfaces 640 and 641 of the motor board 64.

In Modification 4, the rotational body illumination light source 65 may be located so as to illuminate the rotational indicator 4 through a different portion from the motor main body 63. In Modification 5, the rotational body illumination light source 65 may not be provided. In Modification 6, three or more sets of the locking arms 615 and the locking claws 616 may be arranged at substantially equal intervals or the like around the rotational body illumination light source 65 on the rotation center line C, for example.

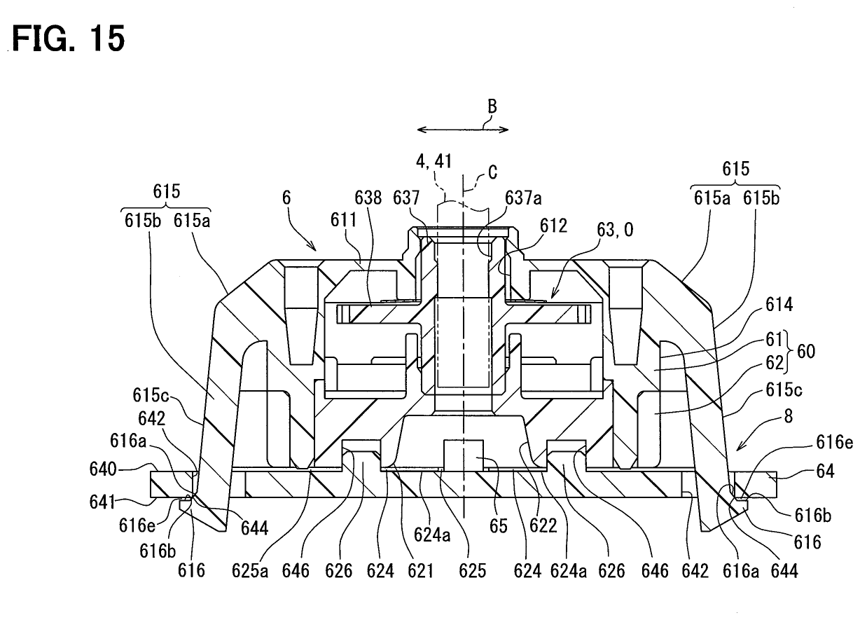

In Modification 7, as shown in FIG. 15, the positioning protrusions 626 may be provided on the motor board 64, while the positioning holes 646 may be provided on the motor casing 60. In Modification 8, the sets of the positioning protrusions 626 and the positioning holes 646 may be arranged to be more distant from the rotational body illumination light source 65 than the sets of the locking arms 615 and the locking claws 616 in the reference direction B. In Modification 9, three or more sets of the positioning protrusions 626 and the positioning holes 646 may be arranged at substantially equal intervals or the like, for example, around the rotational body illumination light source 65 on the rotation center line C. In Modification 10, there is no necessary to provide the set of the positioning protrusions 626 and the positioning holes 646.

In Modification 11, the sets of the positioning protrusion 626 and the positioning holes 646 may be located so as to avoid the gaps 625 (625a) between the dike protrusions 624. In Modification 12, the bottom portion 621 of the second case member 62 may directly abut against the mounting surface 640 of the motor board 64 without providing the dike protrusions 624.

In Modification 13, there is no need to provide the chamfered portion 613 in the first case member 61. In Modification 14, the display illumination light source 66 may not be provided. In Modification 15, the present disclosure may be applied to a device other than the indicator instrument 1 for a vehicle, such as a head-up display (HUD), and the “rotational body” of the device may be rotationally driven by the step motor 6.

In Modification 16, the locking arm 615 may extend substantially perpendicularly to both the surfaces 640 and 641 of the motor board 64. In Modification 17, the locking claw 616 may be deformed so as to abut against both the locking surface 641 of the motor board 64 and the inner surface of the locking hole 642.

The step motor 6 rotationally drives the rotational body 4. The step motor 6 includes the motor main body 63 for providing the rotational driving force to the rotational body, the motor casing 60 accommodating the motor main body, and the motor board 64 for holding the motor casing. The motor board has the mounting surface 640 on which the motor main body is mounted through the motor casing, the locking surface 641 on the opposite side of the mounting surface, and the locking hole 642 penetrating between the mounting surface and the locking surface. The motor casing has a locking arm 615 and locking claws 616, 2616. The locking arm 615 is inserted into the locking hole in an elastically deformed state extending obliquely with respect to the mounting surface and the locking surface. The locking claws 616 and 2616 form abutment surfaces 616a and 2616a extending obliquely with respect to the mounting surface and the locking surface, and are locked to the motor board in a state in which the abutment surfaces abut against the locking corner portions 644 formed by the locking surfaces and the locking holes in the motor board.

In addition, the configuration described above includes the step motor 6 and the rotational indicator 4 that indicates a vehicle state value as the rotational body. According to those configurations, in the motor casing, the locking claw locked to the motor board abuts the mounting surface of the motor board and the abutment surface extending obliquely to the locking surface on the board against the locking corner portion formed by the locking surface and the locking hole on the motor board. According to the above configuration, the locking arm is inserted into the locking hole so as to be in an elastically deformed state extending obliquely with respect to the mounting surface and the locking surface of the motor board, thereby being capable of applying the necessary loads in the parallel direction and the vertical direction with respect to both of those surfaces at the abutment portion of the abutment surface against the locking corner portion. Therefore, in order to increase the vibration resistant strength by the mounting structure of the motor main body to the motor board through the motor casing, the necessity of securing the length of the locking arm along the parallel direction can be relieved. As described above, the mounting structure with improved durability can be reduced in size.

Although the present disclosure has been described in accordance with the embodiments, it is understood that the present disclosure is not limited to such examples or structures. The present disclosure encompasses various modifications and variations within the scope of equivalents. In addition, various combinations and configurations, as well as other combinations and configurations that include only one element, more, or less, are within the scope and spirit of the present disclosure.

1. A step motor configured to rotationally drive a rotational body, the step motor comprising:
a motor main body configured to apply a rotational driving force to the rotational body;
a motor casing accommodating the motor main body; and
a motor board holding the motor casing, wherein
the motor board has
a mounting surface on which the motor main body is mounted via the motor casing,
a locking surface on an opposite side of the mounting surface, and
a locking hole penetrating between the mounting surface and the locking surface,
the motor casing includes
a locking arm inserted in the locking hole in an elastically deformed state in which the locking arm extends obliquely with respect to the mounting surface and the locking surface, and
a locking claw having an abutment surface,
the abutment surface extends obliquely with respect to the mounting surface and the locking surface and locked to the motor board in a state in which the abutment surface is in abutment with a locking corner portion, and
the locking corner portion is formed by the locking surface and a surface of the locking hole in the motor board,
the locking claw has a facing surface which faces the locking surface,
the facing surface is located on a side opposite to the locking arm across the abutment surface,
the abutment surface has a portion, which is between a first boundary portion and a second boundary portion and abuts against the locking corner portion,
the first boundary portion is placed between the locking arm and the abutment surface,
the second boundary portion is placed between the facing surface and the abutment surface, and
the abutment surface is shaped in a embossed surface.

2. The step motor according to claim 1, further comprising:
a rotational body illumination light source mounted on the mounting surface and configured to emit a light across the motor main body to illuminate the rotational body.

3. The step motor according to claim 2, wherein
the motor casing has a set of the locking arm and the locking claw on each of both sides of the rotational body illumination light source in a reference direction.

4. The step motor according to claim 3, wherein
one of the motor casing and the motor board includes positioning protrusions on both sides of the rotational body illumination light source, respectively, in the reference direction, and
the other of the motor casing and the motor board has positioning holes on both sides of the rotational body illumination light source, respectively, in the reference direction to fit with the positioning protrusions and to position the motor casing on the motor board

5. The step motor according to claim 4, wherein
a set of the positioning protrusions and the positioning holes is located closer to the rotational body illumination light source than the set of the locking arm and the locking claw in the reference direction.

6. A step motor configured to rotationally drive a rotational body, the step motor comprising:
a motor main body configured to apply a rotational driving force to the rotational body;
a motor casing accommodating the motor main body; and
a motor board holding the motor casing, wherein
the motor board has
a mounting surface on which the motor main body is mounted via the motor casing,
a locking surface on an opposite side of the mounting surface, and
a locking hole penetrating between the mounting surface and the locking surface,
the motor casing includes
a locking arm inserted in the locking hole in an elastically deformed state in which the locking arm extends obliquely with respect to the mounting surface and the locking surface, and
a locking claw having an abutment surface,
the abutment surface extends obliquely with respect to the mounting surface and the locking surface and locked to the motor board in a state in which the abutment surface is in abutment with a locking corner portion,
the locking corner portion is formed by the locking surface and a surface of the locking hole in the motor board,
the step motor further comprising:
a rotational body illumination light source mounted on the mounting surface and configured to emit a light across the motor main body to illuminate the rotational body, wherein
the motor casing has a set of the locking arm and the locking claw on each of both sides of the rotational body illumination light source in a reference direction,
one of the motor casing and the motor board includes positioning protrusions on both sides of the rotational body illumination light source, respectively, in the reference direction,
the other of the motor casing and the motor board has positioning holes on both sides of the rotational body illumination light source, respectively, in the reference direction to fit with the positioning protrusions and to position the motor casing on the motor board, wherein
the motor casing further includes dike protrusions which project at a plurality of locations, respectively, around the rotational body illumination light source and is in surface contact with the mounting surface,
the dike protrusions define gaps therebetween, and
the positioning protrusions are located in the gaps.

7. A step motor configured to rotationally drive a rotational body, the step motor comprising:
a motor main body configured to apply a rotational driving force to the rotational body;
a motor casing accommodating the motor main body; and
a motor board holding the motor casing, wherein
the motor board has
a mounting surface on which the motor main body is mounted via the motor casing,
a locking surface on an opposite side of the mounting surface, and
a locking hole penetrating between the mounting surface and the locking surface,
the motor casing includes
a locking arm inserted in the locking hole in an elastically deformed state in which the locking arm extends obliquely with respect to the mounting surface and the locking surface, and
a locking claw having an abutment surface,
the abutment surface extends obliquely with respect to the mounting surface and the locking surface and locked to the motor board in a state in which the abutment surface is in abutment with a locking corner portion, and
the locking corner portion is formed by the locking surface and a surface of the locking hole in the motor board,
the step motor further comprising:
a rotational body illumination light source mounted on the mounting surface and configured to emit a light across the motor main body to illuminate the rotational body, wherein
the motor casing further includes dike protrusions which project at a plurality of locations, respectively, around the rotational body illumination light source and is in surface contact with the mounting surface, and
the dike protrusions define gaps therebetween.

8. An indicator instrument for a vehicle comprising:
a step motor configured to rotationally drive a rotational body, the step motor including:
a motor main body configured to apply a rotational driving force to the rotational body;
a motor casing accommodating the motor main body; and
a motor board holding the motor casing, wherein
the motor board has
a mounting surface on which the motor main body is mounted via the motor casing,
a locking surface on an opposite side of the mounting surface, and
a locking hole penetrating between the mounting surface and the locking surface,
the motor casing includes
a locking arm inserted in the locking hole in an elastically deformed state in which the locking arm extends obliquely with respect to the mounting surface and the locking surface, and
a locking claw having an abutment surface,
the abutment surface extends obliquely with respect to the mounting surface and the locking surface and locked to the motor board in a state in which the abutment surface is in abutment with a locking corner portion, and
the locking corner portion is formed by the locking surface and a surface of the locking hole in the motor board,
a rotational indicator configured to indicate a vehicle state value as the rotational body; and
a display member configured to display the vehicle state value, wherein
the step motor further includes a display illumination light source mounted on the mounting surface and configured to emit a light to illuminate the display member; and
the motor casing further includes a chamfered portion chamfered to form an optical path from the display illumination light source toward the display member.

9. The step motor according to claim 7, wherein
the motor casing has a set of the locking arm and the locking claw on each of both sides of the rotational body illumination light source in a reference direction.

10. The step motor according to claim 9, wherein
one of the motor casing and the motor board includes positioning protrusions on both sides of the rotational body illumination light source, respectively, in the reference direction, and
the other of the motor casing and the motor board has positioning holes on both sides of the rotational body illumination light source, respectively, in the reference direction to fit with the positioning protrusions and to position the motor casing on the motor board

11. The step motor according to claim 10, wherein
a set of the positioning protrusions and the positioning holes is located closer to the rotational body illumination light source than the set of the locking arm and the locking claw in the reference direction.

12. The step motor according to claim 6, wherein
the locking claw has a facing surface which faces the locking surface, and
the facing surface is located on a side opposite to the locking arm across the abutment surface.

13. The step motor according to claim 12, wherein
the abutment surface has a portion, which is between a first boundary portion and a second boundary portion and abuts against the locking corner portion,
the first boundary portion is placed between the locking arm and the abutment surface, and
the second boundary portion is placed between the facing surface and the abutment surface.

14. The step motor according to claim 13, wherein
the abutment surface is inclined at an angle of 45° with respect to the mounting surface and the locking surface.

15. The step motor according to claim 6, wherein
the abutment surface is shaped in a embossed surface.

16. The step motor according to claim 7, wherein
the locking claw has a facing surface which faces the locking surface, and
the facing surface is located on a side opposite to the locking arm across the abutment surface.

17. The step motor according to claim 16, wherein
the abutment surface has a portion, which is between a first boundary portion and a second boundary portion and abuts against the locking corner portion,
the first boundary portion is placed between the locking arm and the abutment surface, and
the second boundary portion is placed between the facing surface and the abutment surface.

18. The step motor according to claim 17, wherein
the abutment surface is inclined at an angle of 45° with respect to the mounting surface and the locking surface.

19. The step motor according to claim 7, wherein
the abutment surface is shaped in a embossed surface.

20. An indicator instrument for a vehicle comprising:
the step motor according to claim 1, and
a rotational indicator configured to indicate a vehicle state value as the rotational body.

21. The indicator instrument according to claim 20, further comprising:
a display member configured to display the vehicle state value, wherein
the step motor further includes a display illumination light source mounted on the mounting surface and configured to emit a light to illuminate the display member; and
the motor casing further includes a chamfered portion chamfered to form an optical path from the display illumination light source toward the display member.

22. An indicator instrument for a vehicle comprising:
the step motor according to claim 6, and
a rotational indicator configured to indicate a vehicle state value as the rotational body.

23. The indicator instrument according to claim 22, further comprising:
a display member configured to display the vehicle state value, wherein
the step motor further includes a display illumination light source mounted on the mounting surface and configured to emit a light to illuminate the display member; and
the motor casing further includes a chamfered portion chamfered to form an optical path from the display illumination light source toward the display member.

24. An indicator instrument for a vehicle comprising:
the step motor according to claim 7, and
a rotational indicator configured to indicate a vehicle state value as the rotational body.

25. The indicator instrument according to claim 24, further comprising:
a display member configured to display the vehicle state value, wherein
the step motor further includes a display illumination light source mounted on the mounting surface and configured to emit a light to illuminate the display member; and
the motor casing further includes a chamfered portion chamfered to form an optical path from the display illumination light source toward the display member.
